(19) United States
(12) Patent Application Publication
(10) Pub. No.: US 2005/0109792 A1
(43) Pub. Date: May 26, 2005

(54) Method and device for detecting and checking the quality or properties of a mixture of fluids, in particular a food or domestic mixture

(75) Inventors: Andrea Fiorini, Casale Monferrato(Alessandria) (IT); Costanzo Gadini, Frassineto Po(Alessandria) (IT)

Correspondence Address: SUGHRUE MION, PLLC, 2100 PENNSYLVANIA AVENUE, N.W., SUITE 800, WASHINGTON, DC, 20037, US

(73) Assignee: ELTEK S.P.A.

(21) Appl. No.: 11/012,152

(22) Filed: Dec. 16, 2004

Related U.S. Application Data
(63) Continuation of application No. PCT/IB03/02677, filed on Jun. 13, 2003.

(30) Foreign Application Priority Data
Jun. 17, 2002 (IT) TO2002-A000519

(51) Int. Cl. B67B 7/00

(52) U.S. Cl. 222/1

(57) ABSTRACT

A device for controlling or preparing a mixture of fluids, in particular a food or domestic mixture, comprises at least two addition ducts for a first and a second fluid getting in (5B), an area where the two fluids are mixed (23), so as to obtain a mixture getting out, and control means (SC) for flow rate adjusting elements (13B) for the first and second fluid, arranged on the addition ducts. The invention envisages detecting means (29) for one or more physical-chemical properties of at least one among said mixture, first fluid and second fluid. In a preferred embodiment the detected physical-chemical quantity is pH.

### BACKGROUND OF THE INVENTION

1. Field of the Invention

The present invention refers to a method and a device for detecting and controlling the quality or properties of a mixture of fluids, in particular a food or domestic mixture, to be used advantageously though not exclusively in drink vendors.

2. Description of the Related Art

Some drinks, such as for instance non-alcoholic drinks, consist of a mixture of at least two liquid ingredients, usually a concentrated syrup and water, the latter suitably diluting the syrup; in order to be supplied to the consumer said drinks can be prepared with the two following methods:
pre-mix system, in which concentrated syrup and water are mixed by the producer of the drink, and the latter is supplied ready and possibly fizzing to the consumer, in a bottle or other container;
post-mix system, in which syrup and water are mixed directly by the consumer, or by an operator, on the spot where the drink is supplied.

A post-mix system, in which the invention described below can be advantageously used, is therefore based on the use of a drink vendor comprising a device mixing concentrated syrup and water (possibly added with gas) in the ratios as provided by the specific characteristics indicated by the producer of the drink.

A main component of a post-mix system is therefore the device mixing the two components straight before being supplied to the consumer. Said mixing device typically comprises at least two electric valves, for water and syrup respectively, installed so as to operate together; the two aforesaid valves are generally integrated into one module shaped as one multi-way valve or mixing valve.

A mixing valve loses mixing accuracy as time passes, due to wear, scaling and deposits of substances, which result in an alteration of the organoleptic features of the drink. It is therefore quite common to perform a post-setting, carried out manually by the consumer or by an operator, so as to retrieve the correct operation of the system.

The manual setting of the mixing valve is usually carried out by tasting the drink or as suggested by the consumer; it is therefore quite obvious that it is a wholly subjective operation exposed to a high level of inaccuracy; another drawback related to manual setting consists in that it usually requires time and is not generally easy to be carried out.

In order to obviate said drawbacks control methods and devices based on the detection of hydraulic or chemical-physical properties of the water-syrup mixture have been proposed to this purpose.

The most traditional solutions envisage the use of flow meters for syrup and water, so as to measure the instantaneous flow rate of the fluid ingredients and to adjust the mixing ratio consequently by acting onto the mixing valve; said system however, cannot evaluate possible changes in the nature of the fluids (such as for instance a variation in syrup concentration and/or viscosity) and is therefore subject to several mistakes.

In other systems the mixing operation is based on the measurement of the percentage of sugar, usually known as “Brix”, present in a final mixture comprising known ratios of water and syrup; as in the technique mentioned above, even a slight variation of the volume used for this measurements results in great mistakes in the final measurement.

In further systems, conversely, the mixing operation is regulated on the basis of the measurement of electric conductivity (see for instance U.S. Pat. No. 6,387,424) or refractive index (see for instance U.S. Pat. No. 6,374,845) referred to the mixture of water and syrup, the detection of said parameters being carried out by means of sensors installed on the outlet of the device, i.e. downstream from the control valves for the ingredients.

Said systems allow to carry out a measurement in real time on the liquid supplied to the user, so as to determine accurately the current mixing ratio between syrup and water and possibly to change it in case it differs from parameters pre-stored in the control system of the system. It should be pointed out that the measurements concerning conductivity and refractive index depend on external factors, first of all temperature variation, liquid pressure and, if present, the gas added to the mixture, which strongly modify the experimental result; in said light the aforesaid system should preferably be provided also with detecting means for said external factors.

In some situations the quality of the fluid or of the mixture getting out of the post-mix mixing or vending device is subject to variations due to different properties of the fluids or ingredients getting in.

In other words, the post-mix mixing and supplying system is often subject to inaccuracies due to the variation of the features of the ingredients, as well as to the wear of the components, scaling or deposits jeopardizing the correct operation of the device or mixing valve; said inaccuracy in the mixing operation gives rise to a liquid having organoleptic features differing from those that are typical for the drink, thus making it necessary to carry out a manual setting, which is often inaccurate and subjective.

Known methods for controlling mixing operations can therefore be inaccurate due to the mistake related to the measurement of the liquid volume, or due to variations related to the different nature of the mixture components. In said light measurement can be particularly difficult in case of syrups having a strong tendency to sedimentation, i.e. in which hardly soluble particles precipitate on the bottom of the syrup container; in this case the great difference of chemical-physical properties between the high sedimentation sampling area and the average fluid composition can give rise to great mistakes in the measurement and therefore in the control of mixing operations.

### SUMMARY OF THE INVENTION

In its general terms, the present invention envisages to carry out a new mixing device and a corresponding control method enabling to check in a fast, simple and accurate way the quality of the mixing operation taking place between two fluids, and in particular between at least two liquids forming a drink, so as to make the properties of the supplied mixture or drink constant.

These and other aims, which shall be evident in the following, are achieved according to the present invention by means of a device for preparing mixtures of liquids and by a method for detecting and checking the quality of liquid mixtures having the characteristics of the appended claims, which are regarded as an integral part of the present description.

### BRIEF DESCRIPTION OF THE DRAWINGS

Further aims, characteristics and advantages of the present invention shall be evident from the following detailed description and from the accompanying drawings, provided as a mere explaining non-limiting example, in which:

FIG. 1 is a perspective view of a control and/or mixing device for post-mix dispensers carried out according to the invention;

FIG. 2 is a lateral view, partially sectioned, of the device in FIG. 1;

FIG. 3 is partially exploded view of the device in FIGS. 1-4;

FIG. 4 is an exploded view, on larger scale, of some components shown in FIG. 3.

### DESCRIPTION OF PREFERRED EMBODIMENTS OF THE INVENTION

In the following description we shall first refer to a mixing device and method which envisage the detection and control of the quality of drinks, however taking for granted that the applications of the invention comprise a large group of fluids and their mixtures, not necessarily of food origin.

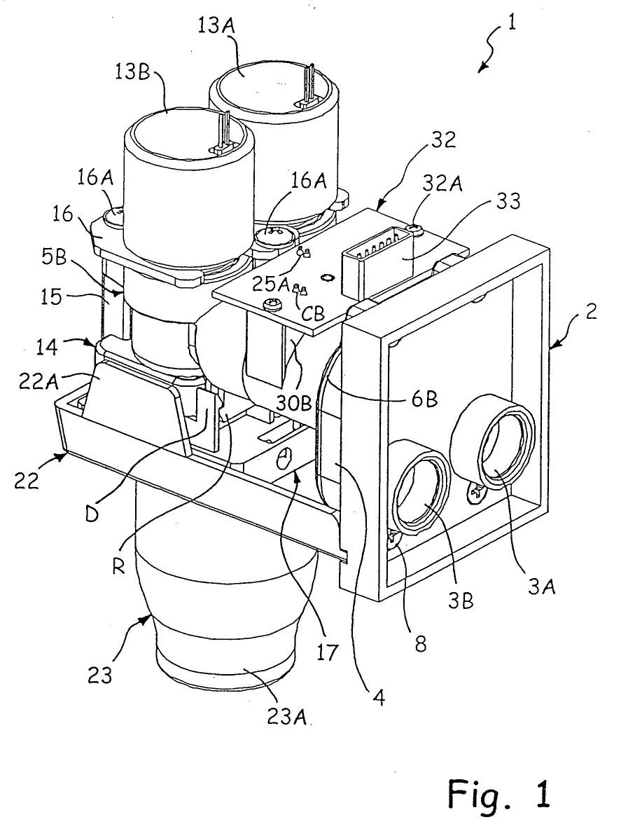

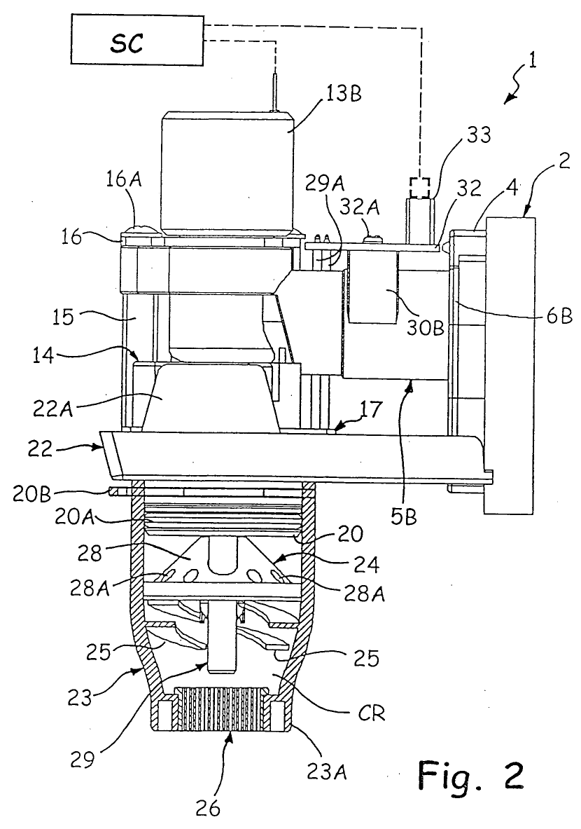

In FIGS. 1 and 2 the numeral 1 globally refers to a mixing device carried out according to the invention; in the case disclosed in the example, the device 1 is a double electric mixing valve for post-mix dispensers, designed to be used in a drink vendor. In said light the device 1, therefore, is used for preparing a drink consisting of two liquid ingredients, in particular water and syrup, and is operative for
receiving and controlling the flow of the first liquid ingredient through a first electric valve,
receiving and controlling the flow of a second liquid ingredient through a second electric valve,
mixing said two ingredients so as to form the mixture, and supplying the latter to a consumer.

According to a first important feature of the present invention, the device 1 is designed to control the quality of the supplied mixture by detecting the acidity and/or basicity of said supplied mixture.

The acidity of a liquid is conventionally expressed as pH, i.e. “negative logarithm of the concentration of H⁺ ions”, which in aqueous solvents varies for the most commons solutions from 0, corresponding to a strong acidity, to 14, corresponding to a strong alkalinity or basicity.

The dilution of a strongly acid compound (for instance with pH=2) involves a sensible variation of the pH of the resulting mixture (for instance a 10-times dilution with pure water would result in a solution with pH=3); according to this principle, the pH value resulting from the mixing operating is therefore related both to the pH of the concentrated fluid (in the practical example syrup) and to the pH of the diluting fluid (in the practical example water), and above all to the volumes of the two fluids taken into consideration.

This principle is used in the mixing device 1 according to the present invention in order to check the mixing operation between the two ingredients (water and syrup) and, if needed, to optimize their composition. To this purpose the pH of the resulting mixture, i.e. of the supplied drink, is detected by means of a first pH sensor.

The factors that can affect pH measurement in the application here exemplified are:
pH of syrup and pH of water at device inlet, constituting the mixture or drink;
volume of syrup and volume of water constituting the mixture or drink;
operating temperature of syrup, water and their mixture.

The use of pH as operating parameter in the application described here presupposes that the pH of the components used to form a corresponding mixture, i.e. water and syrup, is known.

In a possible embodiment of the invention said pH values can be obtained previously through conventional empirical or experimental analyses, and then be stored in memory means within the control system of the device 1, preferably electronic memory means, schematically referred to with SC in FIG. 2. Moreover, in a possible advantageous embodiment of the invention, the pH values of the mixture components can be measured directly through two further pH sensors operating or present inside the ducts through which water and syrup pass, respectively.

The pH of the water/syrup mixture is further affected by the volume of the two liquids constituting the mixture according to the relations shown below. Let us give some definitions first:
pHₛ=syrup pH
pH_{w}=water pH
pHₘ=mixture pH
Vₛ=syrup volume in the mixture
V_{w}=water volume in the mixture
Vₘ=mixture volume (Vₛ+V_{w})

Starting from the pH values of the constituents (water and syrup), be they stored in the control system SC or measured directly through corresponding sensors, it is possible to calculate the corresponding hydrogen ion concentration of syrup (H⁺)ₛ, of water (H⁺)_{w} and of mixture (H⁺)ₘ:
(H⁺)ₛ=10 exp(−pHₛ) (1.1)
(H⁺)_{w}=10 exp(−pH_{w}) (1.2)
(H⁺)ₘ=10 exp(−pHₘ) (1.3)
from which:

$${( {H}^{+} )}_{m} = \frac{\{ {{V}_{s} ( {H}^{+} )}_{s} + {{V}_{w} ( {H}^{+} )}_{w} \}}{\{ {V}_{s} + {V}_{w} \}} \qquad ( 2 )$$

pHₘ=−Log(H⁺)ₘ (3)

From the relation (2) it can be inferred how pH and the volumes of liquid components affect the pH of the resulting mixture; it can further be noted how a possible variation of the volumes originally envisaged gives rise to a variation on the pH of the mixture.

If the calculation is carried out inversely, it is also evident that by measuring the pH of the mixture through a suitable sensor, and previously knowing or measuring the pH of its components, it is possible to carry out a convenient adjustment of water and syrup volumes by acting upon their respective adjustment valves.

It should be noted that the relation (2) can be simplified in case the pH values of syrup and water are very different (for instance: syrup with pH=3 and water with pH=7); in this case the term {V_{w}(H⁺)_{w}} is basically negligible and the relation (2) can be simplified into:

$${( {H}^{+} )}_{m} = \frac{\{ {{V}_{s} ( {H}^{+} )}_{s} \}}{\{ {V}_{s} + {V}_{w} \}} \qquad ( 4 )$$

in which the pH of the mixture is given by the volume of its components and by the pH of syrup only.

In case the measurement system should be more accurate, it is preferable to take into consideration also the influence of temperature and to compensate its effect conveniently; indeed, the variation of system temperature results both in a variation of the sensibility of pH sensor or sensors, and a real direct effect on the analyzed sample, by modifying its dissociation balance and therefore its pH.

In order to evaluate this variation, the preferred embodiment of the invention will also envisage detecting means for the temperature of the mixture and of its single components, i.e. water and syrup. The control system SC will further be suitably programmed so as to compensate the influence of temperature on pH detection; this can be carried out in per se known ways, for instance using pre-stored data tables, or using fuzzy logic processing techniques.

In the light of the above description it is manifest how, according to the invention, it is possible to define a characteristic pH value of the mixture to be obtained, consisting of correct volumes of its liquid components, as a function of the pH of the syrup and water to be mixed and of their respective operating temperatures.

A measurement of the pH of the final mixture giving rise to anomalous values will then be interpreted by the system SC as due to a mistake in the proportions of the volumes of water and syrup that have been mixed, and the system will automatically correct the supplied volumes of liquid components according to the parameters previously defined in the managing program. In practice, therefore, the method for controlling the quality of the mixing operation according to the invention, implemented by the device 1 in FIG. 1, can include the following steps or basic operations:
i) determination (i.e. measurement and/or predefinition) of the pH value of a first and second liquid ingredient (i.e. water and syrup) used for obtaining a mixture (i.e. the drink in the exemplified case);
ii) determination (i.e. measurement and/or predefinition) of a reference pH value or a range of reference pH values of the mixture to be obtained, the reference value or range of reference values representing the desired quality or properties of the mixture;
iii) addition of the first ingredient, with the control of its flow rate and/or amount, by means of at least a first valve;
iv) addition of the second ingredient, with the control of its flow rate and/or amount, by means of at least a second valve;
v) mixing of the first and second ingredient so as to obtain the mixture and supply it;
vi) measurement of the pH value of said mixture, preferably in an area close to the supply and/or mixing area;
vii) processing of the pH value of the mixture as measured, in particular by comparing it with the corresponding reference value or range of reference values; and
viii) in case of unconformity of the pH value as detected from the reference value or values, adjustment of one or both valves supplying the first and second ingredient, so as to correct the composition of the mixture, so that its pH corresponds to the reference value or falls within the range of reference values.

As previously explained, by measuring the pH of the mixture by means of a suitable sensor and knowing the pH of the two ingredients it is possible to adjust the volumes of the latter by acting upon their respective adjustment valves, so as to obtain a mixture having the desired pH value, which is an indication of the desired quality of the mixture. The aforesaid adjustment can be carried out through processing techniques known per se, for instance using table methods or fuzzy logic procedures.

In a first embodiment of the method the pH values of the first and second liquid ingredient (step i), as well as the reference value or values for the mixture (step ii) can be previously calculated by means of experimental analyses and stored in the control logic supervising the operation of the mixing device 1; conversely, the pH value in the supplied mixture (step vi) will be detected directly through a corresponding sensor. In a second embodiment of the method according to the invention also the pH values of the first and second liquid ingredient (step i) can be detected directly through corresponding sensors.

In both cases, in order to carry out steps vii) and viii) the control logic of the system will correct the various pH values as a function of the temperature of the corresponding liquids.

The accompanying figures show a possible practical embodiment of the device 1, which implements the control method according to the invention.

The device 1 comprises an interconnection element 2, shaped like a plate, designed for a rapid coupling with a drink vending machine, not shown; the interconnection element 2 can be carried out with known techniques, so as to enable a fast mechanical and/or hydraulic and/or electric connection of the device 1 to its corresponding vendor.

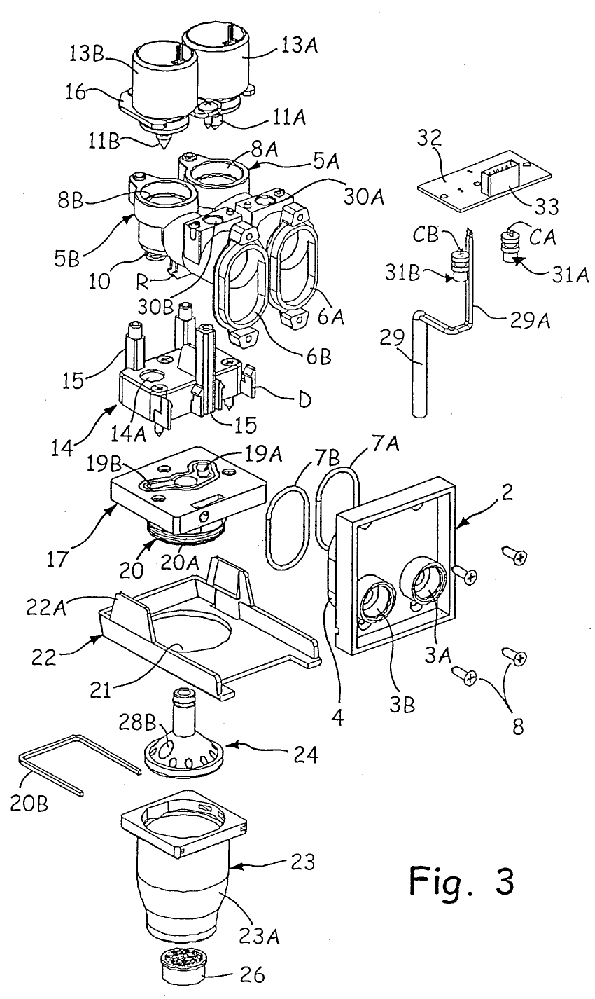

The interconnection element 2 defines two passages, each designed to be connected to a source of a liquid ingredient, which are supposed to be here water and syrup; said passages end up in the inner part of the interconnection element 2 into respective connection fittings, referred to with 3A and 3B, respectively. The opposite part of the interconnection element 2 defines two connecting portions, one of which is referred to with 4 and can be partially seen in FIG. 3, for respective end portions 6A, 6B of two valve bodies, referred to with 5A and 5B, basically parallel to one another and defining a corresponding inner duct. The coupling end portions 6A, 6B of each valve body 5A, 5B are designed to be fitted onto the respective portions 4 of the plate 2, with the interposition of a respective sealing washer 7A, 7B; the fastening between the parts is carried out by means of screws, referred to with 8.

As can be seen in FIG. 3, each valve body 5A, 5B also defines a chamber 8A, 8B housing a corresponding actuating group. Each chamber 8A, 8B, which in the example of FIG. 5 is open upwards, has an inlet and an outlet, which are part of the aforesaid duct within the valve bodies 5A, 5B.

Each chamber 8A, 8B is designed to house a respective shutter 11A, 11B in FIG. 3, actuated by means of a corresponding position-controllable actuator 13A, 13B, in particular a proportional electromagnet, arranged above the corresponding chamber 8A, 8B.

The outlet of each valve body 5A, 5B (one of which is referred to with 10 in FIG. 3) is fitted sealingly into a corresponding passage 14A defined in a hooking element 14, basically cap-shaped, from which uprights 15 and hooking teeth D rise, the latter being designed to couple elastically with projections R defined on the sides of the two valve bodies 5A, 5B. The numeral 16 refers to a bracket, secured by means of screws 16A onto the ends of the uprights 15 of the hooking element 14, so as to keep the electromagnets 13A, 13B in position.

The hooking element 14 is fitted onto an underlying manifold 17 and fastened to the latter by means of screws 14B, with the interposition of a suitable sealing washer; the manifold 17 contains two chambers 19A and 19B, which—referring to the exemplifying drawings—are open upwards, in the area where the outlets 10 of the two valve bodies 5A, 5B end up; said chambers 19A and 19B basically convey water coming from the outlet 10 of the body 5A and syrup coming from the outlet 10 of the body 5B into respective outlets, not visible in the figures, which get in their turn, though being two separate ducts, into a common outlet body of the manifold 17, referred to with 20 in FIGS. 2 and 3.

The outlet body 20, equipped with a peripheral washer 20A, is fitted into a passage 21 getting through a lower plate 22, hooked by means of elastic fins 22A to the manifold 17 and arranged in a basically perpendicular direction with respect to the hooking plate 2. The outlet body 20 is hooked to a supply nozzle, referred to with 23, for instance by means of a U-plug, referred to with 20B; the nozzle 23 can be moved or removed, for instance to cleaning purposes.

The nozzle 23 contains inside a static mixer, carried out in a per se known way; in the exemplified case, as can be seen in FIGS. 2 and 3, said mixer comprises an inner diffusing element 24, an outer body 23A containing a series of helical fins 25, and a pierced lower diffuser 26.

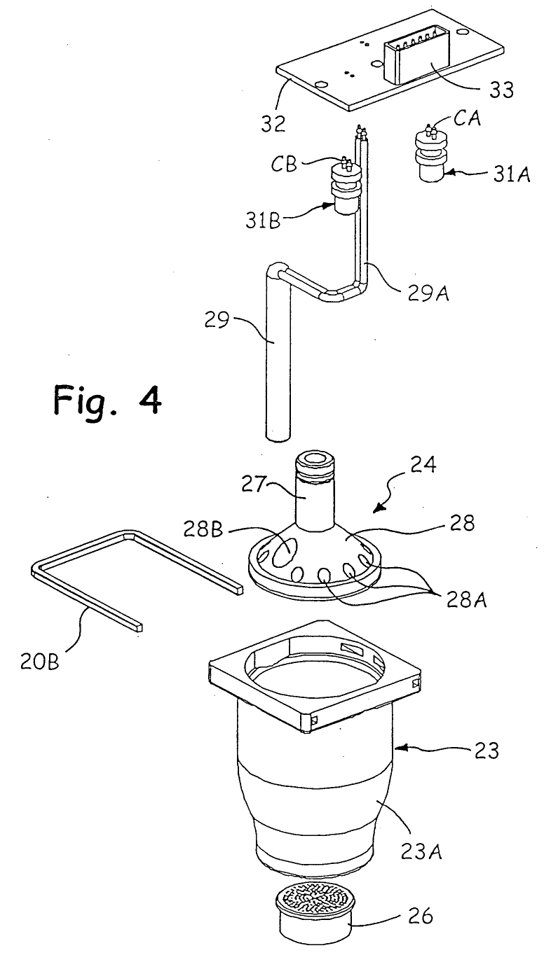

As can be seen in FIG. 4, the inner diffusing element 24 has a hollow cylindrical upper portion 27 and a basically conical lower portion 28; the upper end of the portion 27 is fitted into a corresponding seating defined in the outlet body 20 of the manifold 17, and the portion 28 has a series of passages 28A.

The portion 27 has a corresponding inner duct, in hydraulic communication with the outlet of the chamber 19B, which ends up with some holes forming a spray for the syrup, as known from the state of the art.

The presence of the lower diffuser 26 at the end of the nozzle 23 results in the formation within the nozzle of a chamber, referred to with CR in FIG. 2, between said diffuser 26 and the inner diffuser 28; in said chamber CR, during supply, a temporary store of liquid can form, i.e. of the mixture consisting of water and syrup, despite the continuous flow of the latter through the passages of the lower diffuser 26.

Said lower diffuser 26 has in particular a shape and/or a section slowing down and/or restraining at least a part of the mixed fluid for the time required for pH measurement; this without the formation of permanent liquid stagnations, which might result in measurement mistakes and/or non-hygienic conditions.

The numeral 29 refers to a sensor detecting at least a chemical-physical property of the mixture passing through the chamber CR. Let us suppose that in the exemplified case the relevant quantity is pH and that the sensor 29 is connected or interfaced, in a per se known way, to the control system SC, through respective outlet wires, referred to with 29A.

The sensor 29 comprises a housing or supporting body for a suitable pH meter, for instance a commercially available ISFET solid state sensor. It should be noted that, advantageously, such type of meter can also integrate directly detecting means for liquid temperature.

The supporting body of the sensor 29 is fitted through into a respective opening 28B present in the conical portion 28 of the inner diffusing element 24, so that the aforesaid pH meter is located within the chamber CR; conversely, the upper end of the sensor 29 is fitted into or anyhow coupled sealingly with a corresponding seating defined in the body of the device 1, i.e. an element integral with the aforesaid valve bodies, for instance in the manifold 17, a passage for the outlet wires 29A also starting from said seating.

The mixing device 1 works as follows.

When a drink has to be prepared, the appliance integrating the device 1 acts by mixing a given amount of water and a given amount of syrup. The device 1 is therefore designed to adjust in a known way both the necessary amount of water, let in through the valve body 5A, and the necessary amount of syrup; said metering can take place for instance by means of suitable flow meters or by proportionally adjusting and/or by opening for a given time the intake duct within the valve body 5A, 5B, through the corresponding shutter 11A, 11B.

The connections 3A and 3B are then connected to the corresponding water and syrup sources.

After a drink request, carried out for instance by manually acting upon an electric switch, the control system SC on one hand suitably excites the electromagnet 13B; this results in that the shutter 11B protruding into the duct within the valve body 5B is lifted, so as to conveniently open the respective inlet leading to the chamber 8B; the syrup then gets into the chamber 8B and flows through the outlet 10 into the respective chamber 19B of the manifold 17. The electromagnet 13B is excited in the way and as long as it is deemed as necessary in order to obtain the desired amount of syrup.

On the other hand, the control system SC excites basically in the same way also the electromagnet 13A. Thus, the water getting in from the connection 3A reaches the chamber 8A of the valve body 5A through the respective inlet 9 not closed by the shutter 11A and then gets out from the outlet 10 within the respective chamber 19A of the manifold 17.

Syrup and water can then reach from said chambers 19A, 19B the nozzle 23; syrup gets through the inner duct within the cylindrical portion 27 of the diffuser 24, on whose bottom it is sent out radially towards the fins 25; the presence of the inner diffusing element 24 slows down and/or divides the water flow, in particular making said water get to the chamber CR through the passages 28A of the conical portion 28; water getting out from the passages 28A reaches the helical fins 25, which end the mixing operation with syrup, and the drink can thus flow through the holes of the lower diffuser 26 and be then supplied.

During said step the sensor 29 detects the pH of the mixture or drink in real time while supply is going on. As was explained above, the pH value thus measured is processed by the control system SC, and in particular compared with a reference value or range of reference values, which indicates the desired quality of the mixture. Should the detected pH value be different from the reference value or values, the position of one or both shutters 11A, 11B will be changed, so as to vary the water and/or syrup flow rate and thus correct the mixture composition until its pH, detected by means of the sensor 29, corresponds to the reference value or falls within the range of reference values.

In the operating example described above it can be supposed that the pH values of water and syrup, which are operating parameters required for the volumetric adjustment of said liquids, are pre-stored in the control system SC.

Moreover, as was said, in a possible advantageous embodiment of the invention the device 1 can be equipped with detecting means for the aforesaid chemical-physical property also for the two components of the mixture, i.e. water and syrup.

To this purpose, as can be noted in particular in FIG. 3, each valve body 5A, 5B defines a positioning seating 30A, 30B for a respective sensor of the same physical-chemical quantity detected by the sensor 29, i.e. pH in the exemplified case.

Also said further sensors, which are referred to in FIG. 3 with 31A and 31B, comprise each a corresponding supporting body for a suitable pH meter, for instance an ISFET solid state pH meter.

The sensors 31A and 31B are fitted sealingly into the seatings 30A, 30B so that the corresponding pH and temperature meters are within the inner ducts of the valve bodies 5A, 5B.

In the exemplified case the outlet wires CA and CB of the sensors 31A and 31B are welded directly to corresponding conductive tracks of a corresponding printed circuit, referred to with 32, which is fastened in its turn onto the valve bodies 5A, 5B by means of screws 32A; also the wires 29A getting out of the sensor 29 are electrically connected to respective conductive tracks of the printed circuit 32; the tracks to which the wires CA, CB and 29A are linked are connected on the other end to one male connector 33 for the connection or interface, by means of a respective female connector and signal conveying cable, with the control system SC.

The working of the device 1 in the embodiment comprising both the sensor 29 and the sensors 31A and 31B is similar to the one previously described, but for that in this case the pH values of water and syrup are detected directly instead of being pre-stored in the control system SC.

It should further be pointed out that the known methods and devices for controlling the mixing amount, based on measurements of conductivity and refractive index as mentioned in the introduction to the present description, envisage a detection only on the outlet, i.e. on the supplied mixture or drink.

Concerning this, however, it should be noted that the chemical-physical properties of the liquid constituents or ingredients (water and syrup) of the drink cannot be regarded as constant in all operating conditions; for instance the electric conductivity of the mixture is strongly affected by water conductivity, which depends in its turn on the features of the water network, and can then vary within a wide range. The same can apply to syrup, whose variations (for instance in its preparation or during its conservation) definitely affect both conductivity and refractive index and pH, and so on, and jeopardize the exactness of the measurement.

In order to overcome said drawback the invention also envisages another method for checking the mixing quality, which can also comprise the detection of the chemical-physical properties of the fluids getting into the device, i.e. the following basic operations:
i) pre-definition of a reference value or range of reference values of at least a chemical-physical quantity of a desired fluid mixture (for instance a drink), the reference value or range of reference values representing a desired quality of the desired mixture;
ii) measurement of at least a first value of the chemical-physical quantity (in the example: pH, conductivity, refractive index, sugar percentage, and so on) of a first fluid ingredient to be used for preparing the desired mixture (water in the example);
iii) measurement of at least a first value of the chemical-physical quantity (in the example: pH, conductivity, refractive index, sugar percentage, and so on) of a second fluid ingredient to be used for preparing the desired mixture (syrup in the example);
iv) determination of control and/or adjustment parameters representing the flow rates and/or amounts of the first and second fluid ingredient required to obtain a mixture whose value of the chemical-physical quantity corresponds to the reference value or falls within the range of reference values, the determination of the control parameters being carried out as a function of the reference value or range of reference values and of the first measured values;
v) addition of the first and second ingredient, with the control of their flow rates and/or amounts based on the control parameters determined, and mixing of the first and second ingredient so as to obtain and supply the desired mixture;
vi) measurement of at least a value of the chemical-physical quantity of the supplied mixture;
vii) processing of the measured value of the chemical-physical quantity of the supplied mixture, in particular by comparing it with the corresponding reference value or range of reference values; and
viii) in case of unconformity between the measured value of the chemical-physical quantity of the supplied mixture and the reference value or values of the desired mixture, change of said parameters.

In practice, therefore, according to the suggested method each drink that can be obtained from the post-mix vendor is associated to a corresponding reference value of the relevant chemical-physical quantity, as stored in the control system SC (step i).

Convenient selection means can be advantageously provided for the control system, so as to couple the mixing device according to the invention with the reference values of the drink to which it has been associated.

In the case of post-mix vendors comprising several mixing devices, the control system can comprise the same number of selection devices, which can be configured for instance by the user or by the appliance operator.

After the request for a drink, the control system SC checks the relevant property of water and syrup getting in by means of the sensors 31A and 31B (steps ii and iii); on the basis of the respective values as measured the control system SC calculates the theoretical flow rates of water and syrup required for obtaining an optimal drink, i.e. whose value of the chemical-physical property corresponds to the reference value; water and syrup flow rates are then adjusted and the two ingredients are mixed so as to obtain the drink, which is then supplied (step v).

The value of the relevant quantity of the supplied mixture is measured by means of the sensor 29 (step vi) and compared with the reference value for the desired drink (step vii); said measuring and comparing step is further necessary in order to compensate possible tolerances of the supply system (step viii), for instance positioning tolerances of the shutters 11A, 11B, in order to ensure the highest level of accuracy as possible.

The aforesaid operating steps can be varied or integrated, but for the final aim of optimizing the measurement and/or adjustment of the product or fluid getting out. Concerning this, it should be noted that in practice the properties of one or both products or fluids getting in can be measured continuously, processing again as a consequence new instantaneous reference parameters for the adjustment of the mixture getting out. In other words, the aforesaid parameters can be varied as a function of possible instantaneous variations of the quality of one or both products getting into the device. Said variation of reference parameters is obviously carried out also as a function of said requirements of dose adjustment and/or compensation, for instance so as to compensate previous false adjustments and/or to compensate possible tolerances of the device.

By using the aforesaid selection means it could further be possible to carry out a selection, for instance by the user, of a reference value (step i) among several predefined reference values, so as to obtain different mixing ratios, as desired.

From the above it can be inferred that by measuring the relevant chemical-physical quantity or quantities of the mixture getting out through a suitable sensor, and by measuring through sensors the same quantity or quantities of the two ingredients getting in, it is possible to adjust the volumes of the latter by acting upon the corresponding adjustment valves, so as to obtain a mixture having the desired value of the relevant quantity or quantities. Also in this case the adjustment can be carried out using processing techniques known per se, for instance table methods or fuzzy logic procedures.

The chemical-physical quantity or quantities that are relevant for the embodiment of the method described above could be different.

For instance, the sensors 29, 31A and 31B could be pH sensors, as in the previous example, or refractive index sensors, sugar percentage sensors, or electric conductivity sensors, and so on, as a function of the relevant property.

For instance, referring to the conductivity of a fluid, the latter can be represented as the inverse of electrical resistance, and given the same measuring conditions, it depends on the ion concentration within the fluid; in general, conductivity increases as a function of concentration in the mixture; however, ion concentration is not the only factor determining the conductivity of a solution: conductivity, as a matter of fact, is affected by “ion migration speed”. The speed with which a ion moves depends on several factors, among which its size, the viscosity of the solution and the temperature of the measurement.

As for pH measurement as described above, temperature is a parameter to be checked in order to obtain accurate conductivity measurements; by way of example it can be pointed out that a rise of 1° C. increases the conductivity of a liquid of about 2%; a temperature rise further reduces the viscosity of the solution and weakens the interaction between solute and solvent, thus making ion movement easier and increasing conductivity as a consequence. Since conductivity is greatly affected by temperature, it is then preferable to check also in this case measuring temperature and suitably compensate the conductivity values obtained.

From the above it can therefore be inferred that it is possible to measure the values of conductivity of syrup and water to be mixed, as well as of the mixture consisting of the correct volumes of the components, in real time, while supply is going on. A measurement giving rise to anomalous values will then be interpreted as due to a mistake in the proportions of the mixed volumes, and the system will automatically correct the supplied volumes according to the parameters predefined in the managing program.

The same can apply, as was said, to other chemical-physical quantities, such as pH or refractive index.

Leaving aside the measured quantity or quantities, in the case of the embodiment described above, the measured value of the chemical-physical quantity or quantities of the mixture will be compared by the control system SC with a corresponding reference value or with the pre-stored range of reference values as a function of the instantaneous properties of the fluids getting in. Should the measured value of the relevant quantity of the mixture be different from the reference value or values, the control system SC will change the position of one or both shutters 11A, 11B, so as to vary the water and/or syrup flow rate and thus correct the mixture composition until the measured value corresponds to the reference value or falls within the range of reference values. The adjustment of the positioning of the shutters 11A and/or 11B will be here carried out both as a function of the measured value of the chemical-physical of water and/or syrup, and as a function of the reference value or range of reference values of the chemical-physical quantity of the mixture.

Obviously, though the principles of the invention remain the same, construction details and materials and embodiments can be widely changed with respect to what has been described and disclosed.

In the case previously disclosed and described by way of example the sensor 29 is fastened directly to the part of the body of the device 1 supporting the supply nozzle 23. In a possible execution variant a sensor 29, whose shape differs from the one shown, can be secured directly to the body 23A of the nozzle 23; said sensor can be equipped with an electric cable and respective electric connector, which can be connected directly to the post-mix dispenser or to a different part of the body of the device 1, such as for instance an electric circuit or connector mounted close to the interconnection element 2.

For instance, the male component of the connector secured to the nozzle 23 will be connected to the wires 29A of the sensor 29, whereas the female element fastened to the manifold 17 will be connected to the wires conveying the signal to the control system SC. Such an expedient can be advantageous so as to simplify the operations for removing the nozzle 23 so as to clean its inner portion.

In a further possible embodiment the sensors 29 and/or 31A and/or 31B could be designed so as to transmit the respective measurements by means of a wireless connection, for instance by radio-frequency, so as to prevent the use of cables or connectors and possibly be fitted into protected areas of the device 1, or completely “immersed” in the liquid to be measured. According to said embodiment the sensors 29 and/or 31A and/or 31B will be associated to wireless signal transmission means, and the control system will be associated to means for receiving said signals.

The measurements of chemical-physical properties of a fluid, such as pH, conductivity, refractive index, sugar percentage, and so on can depend on external factors other than temperature, such as the pressure of the liquid and of the gas possibly added to it. In said light the control system SC can be associated also to means for detecting said factors, so as to calculate their influence on the detections of the relevant chemical-physical properties and conveniently compensate their effect.

Among the other variants of the invention it should be pointed out that there could be an operating stage enabling also the possible correction of the mixture portion already supplied, calculating and supplying a following “compensation” mixture portion directly into the glass; said variant is quite easy to be carried out with reference to the application and method described above based on the presence of detecting means for a property both of the mixture components and of the mixture itself.

For instance, in the initial supply step, while the first measurements of the relevant properties and/or the first corrections of the adjustment are being carried out, a mixture with too much syrup could be supplied; in such a case, having measured in a known way the flow rate of at least one of the supplied liquids (for instance water), it is possible to calculate and supply a further mixture with less syrup, so that the latter gets mixed in the glass with the one containing too much syrup, thus obtaining an optimal average value.

1. A method for detecting and controlling quality or properties of a mixture of fluids, in particular a food or domestic mixture, wherein the following steps are provided:
i) determination of a reference pH value or a range of reference pH values of a mixture to be obtained, the reference value or range of reference values representing a desired quality of the mixture;
ii) addition of a first fluid ingredient, with the control of its flow rate or amount;
iii) addition of a second fluid ingredient, with the control of its flow rate or amount;
iv) mixing of the first and second ingredient so as to obtain the mixture and supply it;
v) detection of the pH value of the supplied mixture;
vi) processing of the pH value of the mixture as measured, in particular by comparing it with the respective reference value or range of reference values, and in case of unconformity of the pH value as detected from the reference value or values,
vii) adjustment of a flow rate or amount of one or both fluid ingredients, so as to correct the composition of the mixture, so that the detected pH value of the mixture corresponds to the reference value or falls within the range of reference values of the mixture to be obtained.

2. The method according to claim 1, wherein there is provided for a step of measurement of the pH value of at least one of the two ingredients.

3. The method according to claim 2, wherein the adjustment of the flow rate or amount of one or both ingredients is carried out at least as a function
of the pH value of the first and/or second ingredient,
of the reference value or range of reference values.

4. The method according to claim 2, wherein the pH value of the first and/or second ingredient is a previously set parameter.

5. The method according to claim 2, wherein the pH value of the first and/or second ingredient is detected by means of a respective sensor during the addition of said ingredient.

6. The method according to claim 1, wherein the pH reference value or range of pH reference values is a previously set parameter.

7. The method according to claim 1, wherein there is further provided for a step of compensation of the influence of at least one between temperature and pressure of the mixture on the respective pH value as detected.

8. The method according to claim 4, wherein there is further provided for a step of compensation of the influence of at least one between temperature and pressure of the first and/or second ingredient on the respective previously set pH value.

9. The method according to claim 5, wherein there is further provided for a step of compensation of the influence of at least one between temperature and pressure of the first and/or second ingredient on the respective pH value as detected.

10. The method according to claim 1, wherein the mixture comprises an added gas and there is provided for a step of compensation of the influence of the pressure of said gas on the detection of the pH value of the mixture.

11. The method according to claim 1, wherein the detected pH value of the mixture is transmitted by means of a wireless connection to a control logic.

12. The method according to claim 2, wherein the pH value of the first and/or second ingredient is transmitted by means of a wireless connection to a control logic.

13. The method according to claim 1, wherein the first liquid ingredient is a concentrated syrup, the second liquid ingredient is water and the supplied mixture is a drink.

14. The method according to claim 1, wherein steps v), vi) and, if necessary, vii) are carried out continuously or repeated several times during a same step of mixture supply.

15. The method according to claim 5, wherein the pH value of the first and/or second ingredient is detected continuously or several times during a same step of mixture supply.

16. A method for detecting and controlling quality or properties of a mixture of fluids, in particular a food or domestic mixture, comprising the following steps:
i) determination of a reference value or a range of reference values of at least a chemical and/or physical quantity for a fluid mixture to be obtained, said reference value or range of reference values representing a desired quality or property of the mixture;
ii) addition of a first fluid ingredient of the mixture, with the control of its flow rate or amount;
iii) addition of a second fluid ingredient of the mixture, with the control of its flow rate or amount;
iv) mixing of the first and second ingredient so as to obtain the mixture and supply it;
v) detection of a value of said quantity of the supplied mixture;
vi) processing of the detected value of said quantity of the mixture, in particular by comparing it with the respective reference value or range of reference values, and in case of unconformity of the detected value of said quantity of the mixture from the reference value or values,
vii) adjustment of a flow rate or amount of one or both fluid ingredients, so as to correct the composition of the mixture, so that the respective detected value of said quantity corresponds to the reference value or falls within the range of reference values of the mixture to be obtained,
wherein
it is provided for the detection of the value of said quantity of at least one between the first and second ingredient by means of a respective sensor and during the addition of said ingredient, and
the adjustment of a flow rate or amount of one or both ingredients is carried out at least as a function of the detected value of said quantity of the first and/or second ingredient and of the reference value of range of reference values of said quantity.

17. A method for detecting and controlling quality or properties of a mixture of fluids, in particular a food or domestic mixture, comprising the following steps:
i) pre-definition of a reference value or range of reference values of at least a chemical and/or physical quantity of a desired fluid mixture, the reference value or range of reference values representing a desired quality of the desired mixture;
ii) determination of control parameters representing flow rates or amounts of a first and second fluid ingredient required to prepare a mixture whose value of the chemical and/or physical quantity corresponds to the reference value or falls within the range of reference values, the determination of the control parameters being carried out as a function of the reference value or range of reference values;
iii) addition of the first and second ingredient, with the control of their flow rates and/or amounts based on the control parameters, and mixing of the first and second ingredient so as to obtain and supply the desired mixture;
iv) measurement of at least a value of the chemical and/or physical quantity of the supplied mixture;
v) processing of the measured value of the chemical and/or physical quantity of the supplied mixture, in particular by comparing it with the corresponding reference value or range of reference values; and
vi) in case of unconformity between the measured value of the chemical and/or physical quantity of the supplied mixture and the reference value or values of the desired mixture, change of said parameters,
wherein the method further comprises:
vii) measurement of at least a first value of the chemical and/or physical quantity of the first ingredient,
viii) measurement of at least a first value of the chemical and/or physical quantity of the second ingredient,
and that the determination of the control parameters as in step ii) is carried out also as a function of the first measured values.

18. The method according to claim 17, wherein said chemical and/or physical quantity is chosen in the group comprising pH, refractive index, electric conductivity, sugar percentage.

19. The method according to claim 17, wherein the reference value or range of reference values is a previously set parameter.

20. The method according to claim 17, wherein it is further provided for a step of compensation of the influence of at least one between temperature and pressure of the mixture on the respective chemical and/or physical quantity.

21. The method according to claim 17, wherein it is further provided for a step of compensation of the influence of at least one between temperature and pressure of the first and/or second ingredient on the detection of the respective chemical and/or physical quantity.

22. The method according to claim 17, wherein the mixture comprises an added gas and it is further provided for a step of compensation of the influence of the pressure of said gas on the detection of said quantity of the mixture.

23. The method according to claim 17, wherein the detected value of said quantity of the mixture is transmitted by means of a wireless connection to a control logic.

24. The method according to claim 17, wherein the detected value of said quantity of the first and/or second ingredient is transmitted by means of a wireless connection to a control logic.

25. The method according to claim 17, wherein the first liquid ingredient is a concentrated syrup, the second liquid ingredient is water and the supplied mixture is a drink.

26. The method according to claim 17, wherein steps iv), v), vii), viii) and, if necessary, vi) are carried out continuously or repeated several times during a same step of mixture supply.

27. A device for controlling or preparing a mixture of fluids, in particular a food or domestic mixture, comprising:
a first duct (5A) for the addition of a first fluid, on which acts a first element for controlling flow rate or amount (11A, 13A) thereof,
a second duct (5B) for the addition of a second fluid, on which acts a second element for controlling the flow rate or amount (11B, 13B) thereof,
a mixing area (23) of the first fluid with the second fluid, so as to obtain said mixture, the mixing area (23) being operatively placed downstream from said first duct (5A) and said second duct (5B),
control means (SC) operative for controlling the first element (11A, 13A) and the second element (11B, 13B),
wherein there are provided means for detecting the pH value (29, 31A, 31B) of at least one among said mixture, first fluid and second fluid.

28. The device according to claim 27, wherein in the control means (SC) is stored a reference pH value or a range of reference pH values of the mixture to be obtained, the reference value or range of reference values representing a desired quality of the mixture.

29. The device according to claim 28, wherein the controls means (SC) are operative for
processing the detected pH value of the mixture, in particular by comparing it with the corresponding reference value or range of reference values, and in case of deviation of the detected pH value from the reference value or values
controlling the operation of the first element (11A, 13A) and/or of the second element (11B, 13B) so as to vary flow rate or amount of the respective ingredient, in order to correct the composition of the mixture so that its detected pH value corresponds to the reference value or falls within the range of reference values of the mixture to be obtained.

30. The device according to claim 27, wherein the control means are operative for regulating the operation of the first element (11A, 13A) and/or of the second element (11B, 13B) as a function
of the pH value of the first and/or second ingredient,
of the reference value or range of reference values of the mixture to be obtained.

31. The device according to claim 30, wherein the pH value of the first and/or second ingredient is a fixed parameter stored in the control means (SC).

32. The device according to claim 27, wherein there are provided first additional detecting means for at least one between temperature and pressure of the mixture, operatively connected to the control means (SC).

33. The device according to claim 27, wherein there are provided second additional detecting means for at least one among temperature and pressure of the first and/or second ingredient, operatively connected to the control means (SC).

34. The device according to claim 27, wherein the detecting means (29) are operatively arranged within the mixing area (23).

35. The device according to claim 27, wherein the detecting means (29) are operatively arranged in the first and/or second duct (5A, 5B).

36. The device according to claim 32, wherein the detecting means (29) and the first additional detecting means are integrated into one detecting device.

37. The device according to claim 33, wherein the second additional detecting means are integrated into one detecting device together with the detecting means (31A, 31B) for the pH value of at least one between the first and the second ingredient.

38. The device according to claim 34, wherein the mixing area comprises a supply nozzle (23) defining a chamber (CR) for the passage of the mixture, the detecting means (29) operating within said chamber (CR).

39. The device according to claim 38, wherein the detecting means (29) are fastened to a component (17) of the device (1) supporting the supply nozzle (23).

40. The device according to claim 38, wherein the detecting means (29) are secured to the supply nozzle (23), where between the supply nozzle (23) and a component (17) of the device (1) supporting said nozzle is envisaged an electric connection device comprising two disconnectable parts, one being fastened to said component (17) and the other one secured to said nozzle (23).

41. The device according to claim 27, wherein the detecting means (29) are operatively associated to wireless signal transmission means and the control means (SC) comprise means for receiving said signals.

42. The device according to claim 27, wherein it is part of an electric valve.

43. The device according to claim 27, wherein it is part of a drink vendor.

44. A control system for a fluid mixing device, in particular for food or domestic use, comprising:
a first duct (5A) for the addition of a first fluid, on which acts a first element for controlling flow rate or amount (11A, 13A) thereof,
a second duct (5B) for the addition of a second fluid, on which acts a second element for controlling flow rate or amount (11B, 13B) thereof,
a mixing area (23) of the first fluid with the second fluid, so as to obtain said mixture, the mixing area (23) being operatively placed downstream from said first duct (5A) and said second duct (5B),
wherein the control system (SC) is operatively associated to means for detecting the pH value of the mixture, and possibly of at least one between the first and the second fluid, and the control system (SC) is operative for processing, as a function of the pH value as measured, control signals for the first and/or the second element (11A, 11B, 13A, 13B).

45. A control system for a fluid mixing device, in particular for food or domestic use, comprising:
a first duct (5A) for the addition of a first fluid, on which acts a first element for controlling flow rate or amount (11A, 13A) thereof,
a second duct (5B) for the addition of a second fluid, on which acts a second element for controlling flow rate or amount (11B, 13B) thereof,
a mixing area (23) of the first fluid with the second fluid, so as to obtain said mixture, the mixing area (23) being operatively placed downstream from said first duct (5A) and said second duct (5B),
wherein the control system (SC) is operatively associated to means for detecting at least a chemical and/or physical quantity of the mixture and of at least one between the first and the second fluid, and the control system (SC) is operative for processing, as a function of the detected value of said quantity, control signals for the first and/or the second element (11A, 11B, 13A, 13B).

46. A device for controlling or preparing a mixture of fluids, in particular a food or domestic mixture, comprising:
a first duct (5A) for the addition of a first fluid, on which acts a first element for controlling flow rate or amount (11A, 13A) thereof,
a second duct (5B) for the addition of a second fluid, on which acts a second element for controlling flow rate or amount (11B, 13B) thereof,
a mixing area (23) of the first fluid with the second fluid, so as to obtain said mixture, the mixing area (23) being operatively placed downstream from said first duct (5A) and said second duct (5B),
control means (SC) for controlling the first adjusting element (11A, 13A) and the second adjusting element (11B, 13B),
first detecting means (29) for at least a chemical and/or physical quantity of the mixture to be obtained, the first detecting means (29) being operatively connected to the control means (SC),
where in the control means (SC) is stored a reference value or a range of reference values of said quantity, the reference value or range of reference values representing a desired quality of the mixture and the control means are operative for
processing the detected value of said quantity of the mixture, in particular by comparing it with the corresponding reference value or range of reference values, and in case of unconformity of the detected value of quantity from the reference value or values,
controlling the operation of the first adjusting element (11A, 13A) and/or of the second adjusting element (11B, 13B) so as to vary the flow rate or amount of the respective fluid, in order to correct the composition of the mixture so that the detected value of said quantity of the mixture corresponds to the reference value or falls within the range of reference values,
wherein there are provided second detecting means (31A, 31B) of the value of said quantity of at least one of the first and second fluid, operatively connected to the control means (SC), and the control means (SC) is operative for checking the operation of the first adjusting element (11A, 13A) and/or of the second adjusting element (11B, 13B) at least as a function of the detected value of said quantity of the first and/or second fluid and of the reference value or range of reference values of said quantity.

47. The device according to claim 46, wherein said physical-chemical quantity is chosen in the group comprising pH, refractive index, electric conductivity, sugar percentage.

48. The device according to claim 46, wherein there are provided first additional detecting means for at least one between temperature and pressure of the mixture, operatively connected to the control means (SC).

49. The device according to claim 48, wherein there are provided second additional detecting means for at least one among temperature and pressure of the first and/or second fluid, operatively connected to the control means (SC).

50. The device according to claim 46, wherein the first detecting means (29) are operatively arranged within the mixing area (23).

51. The device according to claim 46, wherein the second detecting means (29) are operatively arranged on the first and/or second duct (5A, 5B).

52. The device according to claim 48, wherein the first detecting means (29) and the first additional detecting means are integrated into one detecting device.

53. The device according to claim 49, wherein the second additional detecting means are integrated into one detecting device together with detecting means (31A, 31B) for the pH value of at least one of the first and the second fluid.

54. The device according to claim 46, wherein the first detecting means (29) are operatively associated to wireless signal transmission means and the control means (SC) comprise means for receiving said signals.

55. The device according to claim 46, wherein the second detecting means (29) are operatively associated to wireless signal transmission means and the control means (SC) comprise means for receiving said signals.
